(19) United States
(12) Patent Application Publication
(10) Pub. No.: US 2012/0005017 A1
(43) Pub. Date: Jan. 5, 2012

(54) METHOD AND SYSTEM FOR PROVIDING ADVERTISEMENTS

(75) Inventor: Arpit GUPTA, Delhi (IN)

(73) Assignee: Yahoo! Inc., Sunnyvale, CA (US)

(21) Appl. No.: 12/828,307

(22) Filed: Jul. 1, 2010

(51) Int. Cl. G06Q 30/00

(52) U.S. Cl. 705/14.49

(57) ABSTRACT

An example of a method includes receiving an input. The input includes at least one of a network bandwidth associated with an electronic device, a memory bandwidth associated with the electronic device, and a central processing unit (CPU) bandwidth associated with the electronic device. The method also includes determining, electronically, one or more advertisements based on at least one of the network bandwidth, the memory bandwidth, and the CPU bandwidth. In addition, the method includes providing, electronically, the one or more advertisements.

### BACKGROUND

Over a period of time, advertising using websites has become a common activity. Website owner generates revenue by displaying advertisements on their website. However, it may happen that a webpage is displayed on a display of an electronic device but the advertisements do not get displayed due to limitations of the electronic device. The website owner marks the advertisements as displayed and charges corresponding advertiser. The website owner does not come to know about the fact that the advertisements were not displayed. Further, user experience is also affected as the advertisements are not displayed. Moreover, if the advertisements are bandwidth intensive then the advertisements also affects the display of the webpage, thereby worsening the user experience.

### SUMMARY

An example of a method includes receiving an input. The input includes at least one of a network bandwidth associated with an electronic device, a memory bandwidth associated with the electronic device, and a central processing unit (CPU) bandwidth associated with the electronic device. The method also includes determining, electronically, one or more advertisements based on at least one of the network bandwidth, the memory bandwidth, and the CPU bandwidth. In addition, the method includes providing, electronically, the one or more advertisements.

An example of a system includes a server. The server includes a communication interface. The server also includes a memory to store instructions. Further, the server includes a processor that is coupled to the memory and the communication interface. The processor is responsive to the instructions to receive an input. The input includes at least one of a network bandwidth associated with an electronic device, a memory bandwidth associated with the electronic device, and a central processing unit (CPU) bandwidth associated with the electronic device. The processor is further responsive to the instructions to determine one or more advertisements based on at least one of the network bandwidth, the memory bandwidth, and the CPU bandwidth, and to provide the one or more advertisements.

An example of an article of manufacture includes a machine-readable medium and instructions carried by the machine-readable medium and operable to cause a programmable processor to perform receiving an input. The input includes at least one of a network bandwidth associated with an electronic device, a memory bandwidth associated with the electronic device, and a central processing unit (CPU) bandwidth associated with the electronic device. Further, the instructions cause the programmable processor to determine one or more advertisements based on at least one of the network bandwidth, the memory bandwidth, and the CPU bandwidth, and to provide the one or more advertisements.

### BRIEF DESCRIPTION OF THE FIGURES

FIG. 1 depicts a block diagram of an environment, in accordance with one embodiment;

FIG. 2 illustrates a method for providing advertisements by a server, in accordance with one embodiment;

FIG. 3 illustrates a method for providing advertisements by an electronic device, in accordance with one embodiment;

FIG. 4 depicts a block diagram of a server, in accordance with one embodiment.

### DETAILED DESCRIPTION OF THE EMBODIMENTS

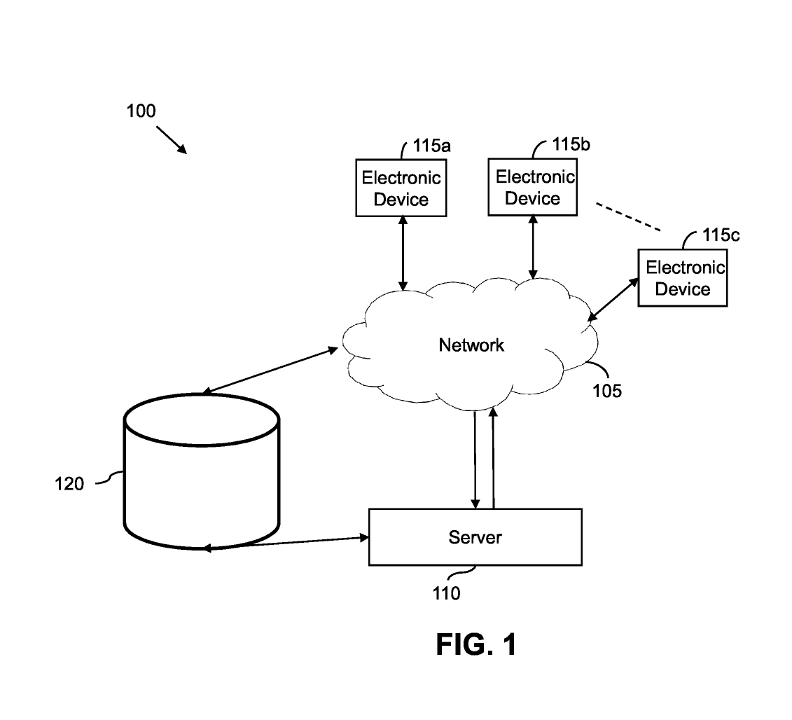

FIG. 1 depicts a block diagram of an environment 100. The environment 100 includes a server 110 connected to a network 105. The environment 100 further includes one or more electronic devices, for example an electronic device 115A, an electronic device 115B and an electronic device 115C which can communicate with each other through the network 105. Examples of the electronic devices include, but are not limited to, computers, mobile devices, laptops, palmtops, and personal digital assistants (PDAs). The electronic devices can also communicate with the server 110 through the network 105.

The server 110, for example a Yahoo!® server can be coupled to a storage device 120.

The environment 100 can also include an advertisement server that can be in electronic communication with the server 110 through the network 105.

An example of interaction among various entities in the environment 100 is now provided.

A user of the electronic device 115A wishes to open a web page. The user types a uniform resource locator (URL), for example www.yahoo.com, for the webpage in a browser.

In one embodiment, the user of the electronic device 115A may get a pop-up for installation of a plug-in. The plug-in has the capability to obtain a memory bandwidth associated with the electronic device 115A, a central processing unit (CPU) bandwidth associated with the electronic device 115A and a network bandwidth associated with the electronic device 115A. The plug-in can obtain such details from a processor of the electronic device 115A or from other applications running on the electronic device 115A.

In another embodiment, the plug-in can be automatically enabled in a browser without approvals from the user.

Example of a memory of the electronic device 115A includes SDRAM, DDR or any other memory. The memory bandwidth of the electronic device 115A can be defined as available or free memory. The memory bandwidth can be extracted from task manager application and can be expressed in gigabytes or megabytes or kilobytes or any other unit.

CPU bandwidth can be defined as available bandwidth of a CPU of the electronic device. The CPU bandwidth can be expressed as a percentage of total CPU bandwidth. The CPU bandwidth can be extracted from the task manager application running on the electronic device 115A.

Network Bandwidth can be defined as speed of internet connection of the electronic device 115A. For example, total link speed or total speed can be 100 Mbps while the speed of the internet connection that is actually available can be 256 Kbps. The network bandwidth indicates capacity of network connection. The network bandwidth can be obtained through an application capable of tracking the speed of the internet connection. For example, network bandwidth can include download speed obtained through website www.speedtest.net.

The browser obtains the memory bandwidth, the CPU bandwidth, and the network bandwidth and sends them along with the URL to the server 110 using cookies.

The server 110 receives the URL, the memory bandwidth, the CPU bandwidth and the network bandwidth. The server 110 then compares the network bandwidth with a first threshold, the memory bandwidth with a second threshold, and the CPU bandwidth against a third threshold. If the network bandwidth exceeds the first threshold, the memory bandwidth exceeds the second threshold, and the CPU bandwidth exceeds the third threshold then the server 110 determines advertisements of a first type. The advertisements of the first type can be referred to as high quality advertisements that are bandwidth intensive. The advertisements can be identified or determined from the storage device 120 or the advertising server. Several other existing criteria can be checked before identifying the advertisements.

If any of the network bandwidth, the CPU bandwidth, and the memory bandwidth does not exceed their respective threshold then advertisements of a second type are determined by the server. The advertisements of the second type can be referred to as low quality advertisements that are not bandwidth intensive.

Thresholds can be determined by the server 110 based on bandwidth required by advertisements. In one embodiment, the advertisements can be categorized as the advertisements of the first type and as the advertisements of the second type and stored. One first threshold, one second threshold, and one third threshold can be there for all the advertisements. Advertisers can submit two versions of same advertisement. One version of the first type and another version of the second type.

In another embodiment, the thresholds can be set differently for different advertisements. Various advertisements for which thresholds are met can be identified. The thresholds can also be provided by advertisers and stored by the server 110.

Various other modifications, for example grouping of advertisements that correspond to same first threshold, same second threshold, and same third threshold can also be possible.

The server 110 then provides the web page corresponding to the URL along with the advertisements. Providing advertisements that meet bandwidth criteria of the electronic device 115A enhances user experience. Further, since advertisements are selected based on the bandwidth criteria it ensures that the advertisements are displayed on the electronic device 115A along with the web page.

In one embodiment, sending of the network bandwidth, the CPU bandwidth, and the memory bandwidth can be optimized. For example, if the user accesses several web pages supported by the server 110 in a session then internet protocol (IP) address can be sent to the server 110. Instead of sending the network bandwidth, the CPU bandwidth, and the memory bandwidth along with subsequent requests for web pages only the IP address can be sent. The network bandwidth, the CPU bandwidth, and the memory bandwidth corresponding to the IP address can be retrieved from the storage device 120 or a memory of the server 110, if saved.

In another embodiment, the network bandwidth, the CPU bandwidth, and the memory bandwidth can be sent periodically to the server 110 if various web pages from a same website are accessed or the same web page is refreshed several times in a session.

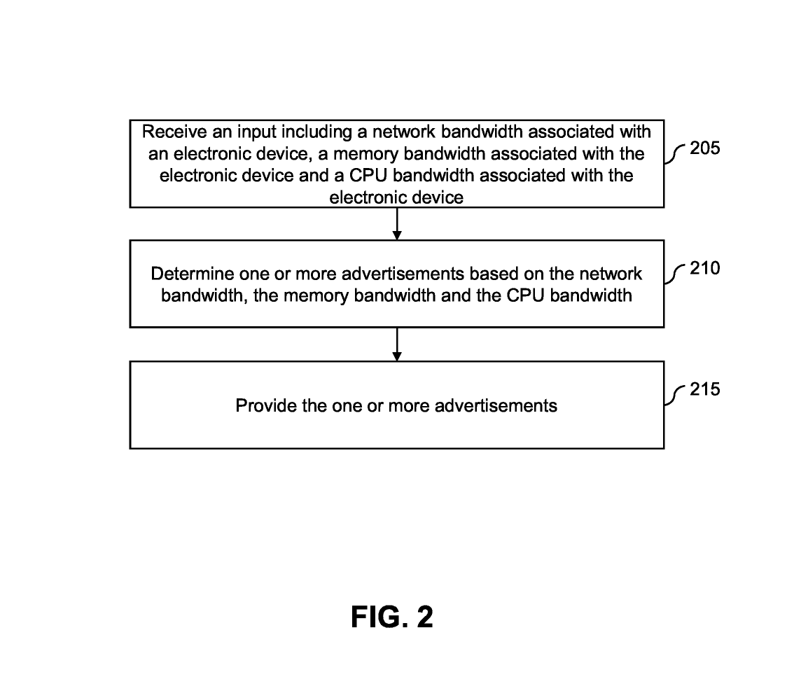

FIG. 2 illustrates a method for providing advertisements by a server, for example the server 110, in accordance with one embodiment;

At step 205, an input is received. The input includes a URL of a web page, a network bandwidth associated with an electronic device, a CPU bandwidth associated with the electronic device, and a memory bandwidth associated with the electronic device.

A user of the electronic device can open a browser and type the URL in the browser. The URL along with bandwidth details is received as the input by the server.

Initially, when the user enters the URL in the browser a pop-up can be shown to the user to install a plug-in having capability of obtaining the bandwidth details.

At step 210, one or more advertisements are determined based on the network bandwidth, the memory bandwidth, and the CPU bandwidth. The network bandwidth, the memory bandwidth, and the CPU bandwidth can collectively be referred to as the bandwidths. The advertisements are determined by comparing the bandwidths against their respective thresholds. If the bandwidths exceed their respective thresholds then advertisements of the first type are identified, else, advertisements of the second type are identified.

In some embodiments, different thresholds can be stored for different advertisements. In such scenario the bandwidths are compared with different thresholds for different advertisements. The advertisements for which thresholds are satisfied can then be determined.

In some embodiments, other parameters or criteria, for example relevance, pricing, priority, targeting is also checked for identifying the advertisements.

In some embodiments, if the bandwidths are not received at step 205 then the bandwidths stored earlier corresponding to the IP address associated with the input can be used.

At step 215, the advertisements are provided. The advertisements are transmitted to the electronic device and can then be displayed to the user on the web page.

In one embodiment, the bandwidths can be updated periodically during a session of the user. In another embodiment, bandwidth optimization can also be done by using the IP address, and storing the bandwidth details corresponding to the IP address.

It is noted that the bandwidths can be associated with the IP address and stored or the bandwidths can be associated with other tags or identifiers for example username and can be stored.

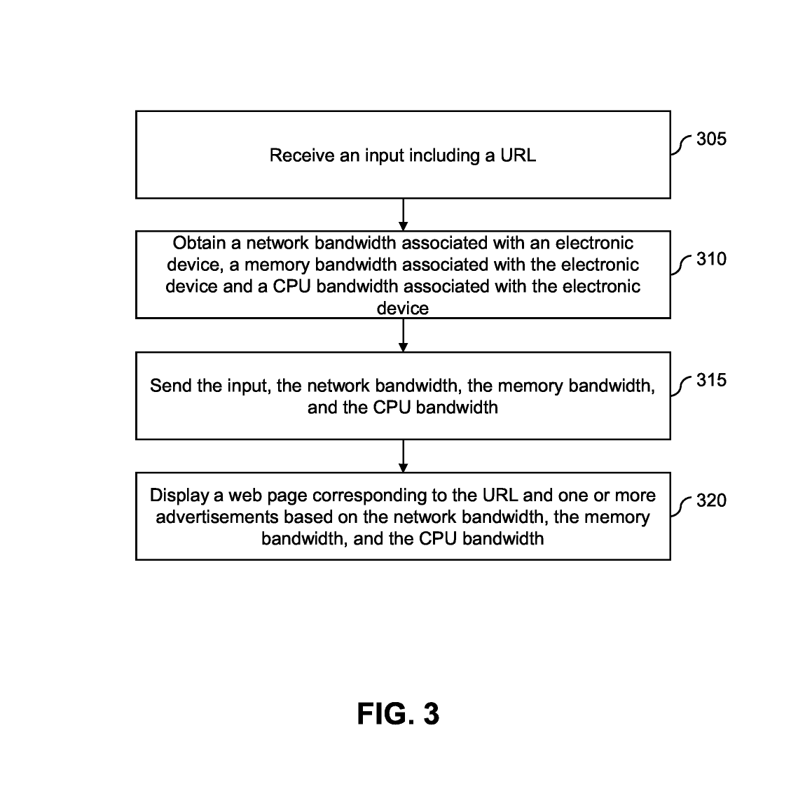

FIG. 3 illustrates a method for providing advertisements by an electronic device, for example the electronic device 115A, in accordance with one embodiment.

At step 305, a URL is received as an input. The user of the electronic device opens a browser and types a URL. The URL is an input for the browser.

At step 310, a network bandwidth associated with the electronic device, a memory bandwidth associated with the electronic device and a CPU bandwidth associated with the electronic device are obtained. The bandwidths can be obtained by the browser from various applications running on the electronic device.

At step 315, the URL and the bandwidths are sent. The URL and the bandwidths are sent to a server, for example the server 110.

At step 320, a web page corresponding to the URL and one or more advertisements are displayed based on the bandwidths. The advertisements are received by the browser from the server.

It is noted that options can be provided to the user to enable advertisement display based on the bandwidths.

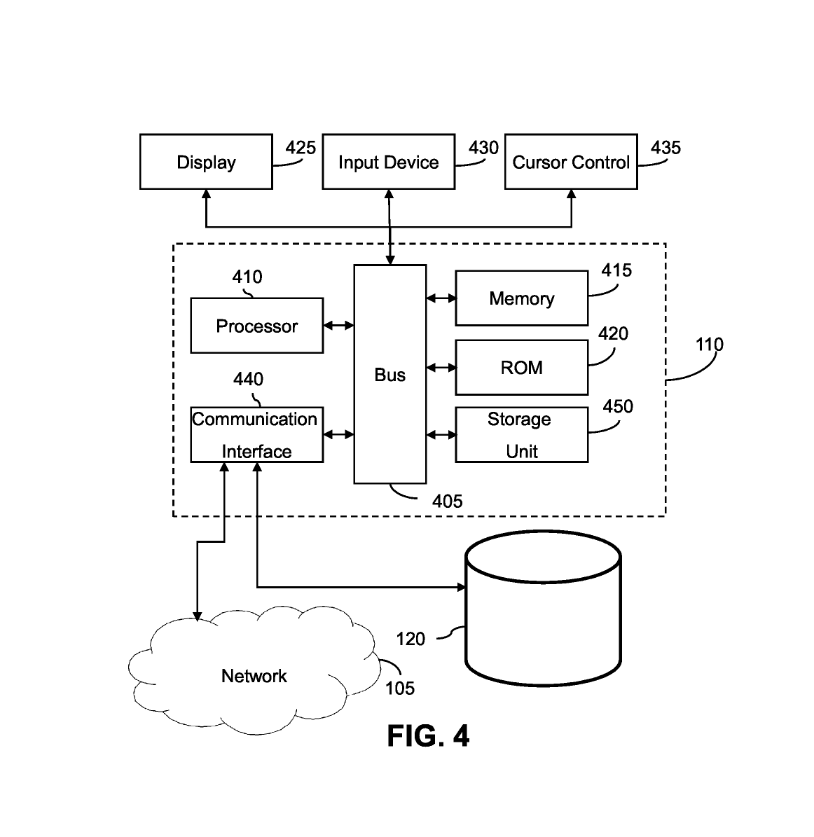

FIG. 4 illustrates a block diagram of the server 110, in accordance with one embodiment. The server 110 includes a bus 405 for communicating information, and a processor 410 coupled with the bus 405 for processing information. The server 110 also includes a memory 415, for example a random access memory (RAM) coupled to the bus 405 for storing instructions to be executed by the processor 410. The memory 415 can be used for storing temporary information required by the processor 410. The server 110 further includes a read only memory (ROM) 420 or other static storage unit coupled to the bus 405 for storing static information and instructions for processor 410. A storage unit 450, such as a magnetic disk or hard disk, can be provided and coupled to the bus 405 for storing information.

The server 110 can be coupled via the bus 405 to a display 425, for example a cathode ray tube (CRT) or liquid crystal display (LCD), for displaying information. An input device 430, including various keys, is coupled to the bus 405 for communicating information and command selections to the processor 410. In some embodiments, cursor control 435, for example a mouse, a trackball, a joystick, or cursor direction keys, for command selections to the processor 410 and for controlling cursor movement on the display 425 can also be present. The functioning of the input device 430 can also be performed using the display 425, for example a touch screen.

Various embodiments are related to the use of the server 110 for implementing the techniques described herein, for example in FIG. 3. The techniques can be performed by the server 110 in response to the processor 410 executing instructions included in the memory 415. The instructions can be read into the memory 415 from another machine-readable medium, such as the storage unit 450. Execution of the instructions included in the memory 415 causes the processor 410 to perform the techniques described herein.

The term machine-readable medium can be defined as a medium providing data to a machine to enable the machine to perform a specific function. The machine-readable medium can be a storage media. Storage media can include non-volatile media and volatile media. The memory 415 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

In some embodiments, the machine-readable medium can be transmission media including coaxial cables, copper wire and fiber optics, including the wires that include the bus 405. Transmission media can also take the form of acoustic or light waves, such as those generated during radio-wave and infra-red data communications. Examples of machine-readable medium may include but are not limited to carrier waves as describer hereinafter or any other media from which the server 110 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 110 can receive the data on the telephone line and use an infra-red transmitter to convert the data to an infra-red signal. An infra-red detector can receive the data carried in the infra-red signal and appropriate circuitry can place the data on the bus 405. The bus 405 carries the data to the memory 415, from which the processor 410 retrieves and executes the instructions. The instructions received by the memory 415 can optionally be stored on the storage unit 450 either before or after execution by the processor 410. All such media must be tangible to enable the instructions carried by the media to be detected by a physical mechanism that reads the instructions into a machine.

The server 110 also includes a communication interface 440 coupled to the bus 405 for enabling data communication. Examples of the communication interface 440 include, but are not limited to, an integrated services digital network (ISDN) card, a modem, a local area network (LAN) card, an infrared port, a Bluetooth port, a zigbee port, and a wireless port.

The server 110 can be coupled to a storage device 120 that stores the advertisements.

In some embodiments, the processor 410 can include one or more processing units for performing one or more functions of the processor 410. The processing units are hardware circuitry performing specified functions.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method comprising:
receiving an input, the input comprising at least one of a network bandwidth associated with an electronic device, a memory bandwidth associated with the electronic device, and a central processing unit (CPU) bandwidth associated with the electronic device;
determining, electronically, one or more advertisements based on at least one of the network bandwidth, the memory bandwidth, and the CPU bandwidth; and
providing, electronically, the one or more advertisements.

2. The method as claimed in claim 1, wherein determining the one or more advertisements comprises:
comparing the network bandwidth against a first threshold, the memory bandwidth against a second threshold and CPU bandwidth against a third threshold;
determining advertisements of first type as the one or more advertisements if the network bandwidth exceeds the first threshold, the memory bandwidth exceeds the second threshold and the CPU bandwidth exceeds the third threshold; and
determining advertisements of second type as the one or more advertisements if the network bandwidth does not exceed the first threshold, the memory bandwidth does not exceed the second threshold and the CPU bandwidth does not exceed the third threshold.

3. The method as claimed in claim 1, wherein providing the one or more advertisements comprises: displaying the one or more advertisements.

4. The method as claimed in claim 1 and further comprising:
storing the network bandwidth, the memory bandwidth and the CPU bandwidth corresponding to the electronic device.

5. A server comprising:
a communication interface;
a memory to store instructions; and
a processor coupled to the memory and the communication interface, and responsive to the instructions to
receive an input, the input comprising at least one of a network bandwidth associated with an electronic device, a memory bandwidth associated with the electronic device, and a central processing unit (CPU) bandwidth associated with the electronic device,
determine one or more advertisements based on at least one of the network bandwidth, the memory bandwidth, and the CPU bandwidth, and
provide the one or more advertisements.

6. The server as claimed in claim 5, wherein the server is electronically coupled to the electronic device to receive the input.

7. The server as claimed in claim 5, wherein the server is electronically coupled to a storage device, the storage device comprising the one or more advertisements.

8. An article of manufacture comprising:
a machine-readable medium; and
instructions carried by the machine-readable medium and operable to cause a programmable processor to perform:
receiving an input, the input comprising at least one of a network bandwidth associated with an electronic device, a memory bandwidth associated with the electronic device, and a central processing unit (CPU) bandwidth associated with the electronic device;
determining one or more advertisements based on at least one of the network bandwidth, the memory bandwidth, and the CPU bandwidth; and
providing the one or more advertisements.

9. The article of manufacture as claimed in claim 8, wherein determining the one or more advertisements comprises:
comparing the network bandwidth against a first threshold, the memory bandwidth against a second threshold and CPU bandwidth against a third threshold;
determining advertisements of first type as the one or more advertisements if the network bandwidth exceeds the first threshold, the memory bandwidth exceeds the second threshold and the CPU bandwidth exceeds the third threshold; and
determining advertisements of second type as the one or more advertisements if the network bandwidth does not exceed the first threshold, the memory bandwidth does not exceed the second threshold and the CPU bandwidth does not exceed the third threshold.

10. The article of manufacture as claimed in claim 8, wherein providing the one or more advertisements comprises: displaying the one or more advertisements.

11. The article of manufacture as claimed in claim 8 and further comprising instructions operable to cause programmable processor to perform:
storing the network bandwidth, the memory bandwidth and the CPU bandwidth corresponding to the electronic device.
